(19) United States
(12) Patent Application Publication
(10) Pub. No.: US 2024/0351234 A1
(43) Pub. Date: Oct. 24, 2024

(54) CUTTER

(71) Applicant: Koki Holdings Co., Ltd., Tokyo (JP)

(72) Inventor: Takuya AMATSU, Ibaraki (JP)

(73) Assignee: Koki Holdings Co., Ltd., Tokyo (JP)

(21) Appl. No.: 18/291,928

(22) PCT Filed: Mar. 25, 2022
(86) PCT No.: PCT/JP2022/014481

§ 371 Date: Jan. 25, 2024

(30) Foreign Application Priority Data
Sep. 10, 2021 (JP) 2021-147902

(51) Int. Cl. B27B 9/02; B27G 19/04

(52) U.S. Cl. CPC B27B 9/02; B27G 19/04

(57) ABSTRACT

The present invention improves workability. In a circular saw, a protrusion-amount-adjusting mechanism includes a lever-biasing spring, and the lever-biasing spring energizes a fixing nut and an operation lever toward a tip end side (i.e., the direction away from a link) of a fixing bolt. Thus, the state of the fixing nut configured at the non-fixed position may be retained well. That is, the separation state of the fixing nut and the operation lever from the link may be retained well. In this way, in the fixing release state of the circular saw body and the base, when the circular saw body is rotated relative to the base, the fixing nut and the operation lever may be prevented from sliding on the link. Thus, workability when adjusting the protrusion amount of the circular saw blade may be improved.

### TECHNICAL FIELD

The present invention relates to a cutter.

### RELATED ART

The cutter described in Patent Document 1 below has a cutting-depth-adjusting mechanism, where the posture of the main body relative to the base is changed by the cutting-depth-adjusting mechanism, and the cutting depth (protrusion amount from the base) of the circular saw blade may be adjusted. To briefly explain this cutting-depth-adjusting mechanism, the cutting-depth-adjusting mechanism includes a link part, a regulating lever, and a pressing member. The link part is fixed to the base, and the regulating lever is provided in the main body part rotatably. Further, the regulating lever includes a cam part, and the pressing member is configured between the cam part and the outer circumferential part of the link part. Then, by rotating the regulating lever to one side in the rotating direction, the cam part presses the pressing member against the outer circumferential part of the link part, and the main body part is fixed to the link part. On the other hand, by rotating the regulating lever to the other side in the rotating direction, the pressing state of the pressing member to the link part is released, and the posture of the main body relative to the base may be changed.

### RELATED ART DOCUMENT

### Patent Document

Patent Document 1: Japanese Patent Application Laid-Open (JP-A) No. 2019-64067

### SUMMARY OF INVENTION

### Technical Problem

However, the cutter in Patent Document 1 has room for improvement in the following points. That is, in the above cutter, since the pressing member is loosely fitted to the shaft provided in the main body part, even in the state where the pressure on the link part of the pressing member by the cam part of the regulating lever is released, the pressing member is still on the outer circumferential part of the link part. When the posture of the body relative to the base is changed in this state, the pressing member moves along the longitudinal direction of the link part while sliding around the outer circumferential part of the link part. This may reduce the workability when adjusting the cutting depth of the circular saw blade.

The present invention takes the above facts into account and aims to provide a cutter that may improve workability.

### Solution to Problem

In one or more embodiments of the present invention, the cutter includes a base formed in a plate shape and having an insertion part; a main body part, provided on one side in a plate thickness direction of the base and including a cutting blade inserted into the insertion part and partially protruding toward other side in the plate thickness direction of the base, a protrusion-amount-adjusting mechanism, connecting the base and the main body part and adjusting a protrusion amount of the cutting blade from the base. The protrusion-amount-adjusting mechanism includes a fixing part, extending from the main body part; a link supported by the base, configured adjacent to a tip end side of the fixing part relative to the main body part and having a link hole through which the fixing part is relatively movably inserted; a pressing part, rotatably provided at a tip end part of the fixing part and displaced to a base end side of the main body part by rotating to one side in a rotating direction to press the link toward the base end side; a lever, integrally rotatably engaged with the pressing part; and an energizing part, energizing the pressing part and the lever toward the tip end side of the fixing part.

In one or more embodiments of the present invention, the cutter is configured such that a threaded part is formed on the tip end part of the fixing part, and the pressing part is screwed onto the threaded part.

In one or more embodiments of the present invention, the cutter is configured such that the pressing part is provided with a stopper that restricts movement of the lever to the tip end side of the fixing part, and the lever is abutted against the stopper by energizing force of the energizing part.

In one or more embodiments of the present invention, the cutter is configured such that the energizing part is configured as a plate spring, and one end part of the energizing part is supported by the main body part, and other end part of the energizing part energizes the lever toward the tip end side of the fixing part.

In one or more embodiments of the present invention, the cutter is configured such that the lever includes a lever engaging part mounted to the pressing part and engaged with the pressing part, the other end part of the energizing part is provided with a mounting part mounted to the pressing part and configured adjacent to a base end side of the fixing part relative to the lever engaging part, and the stopper is configured adjacent to the tip end side of the fixing part relative to the lever engaging part.

In one or more embodiments of the present invention, the cutter is configured such that the pressing part is configured as a hexagon nut, and the lever engaging part and the mounting part are formed in an annular shape configured on the radially outer side of the pressing part.

### Effects of Invention

According to one or more embodiments of the present invention, workability may be improved.

### BRIEF DESCRIPTION OF DRAWING

FIG. 1 is a plan view of the circular saw according to the embodiment of the present invention when viewed from the above.

FIG. 2 is a side view of the circular saw shown in FIG. 1 when viewed from the left side.

FIG. 3 is a side view showing the state in which the circular saw body shown in FIG. 2 is adjusted to the minimum protrusion position.

FIG. 4 is a plan cross-sectional view (cross-sectional view along the line 4-4 in FIG. 2) showing the interior of the circular saw shown in FIG. 2 when viewed from the above.

FIG. 5 is a side view showing the fixing state of the link of the protrusion-amount-adjusting mechanism and saw cover part shown in FIG. 2 when viewed from the left side.

FIG. 6 is an exploded perspective view of the protrusion-amount-adjusting mechanism shown in FIG. 5.

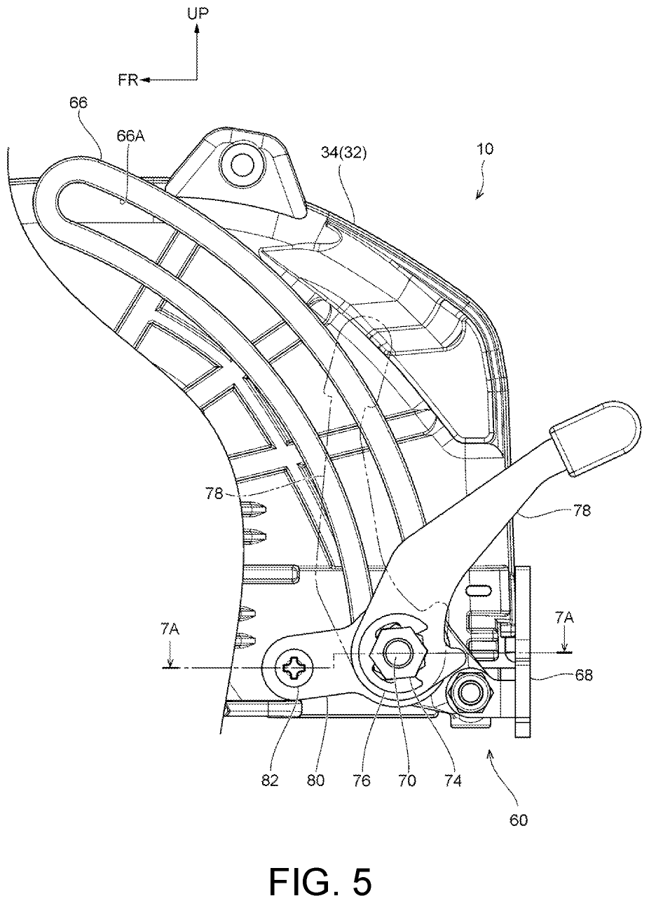

(A) of FIG. 7 is a cross-sectional view (cross-sectional view along the line 7A-7A in FIG. 5) showing the fixing state of the link of the protrusion-amount-adjusting mechanism and the saw cover part shown in FIG. 5 when view from the above, and (B) is a cross-sectional view of the state in which the fixing nut is displaced from the fixed position to the non-fixed position by operating the operation lever in (A) when viewed from the above.

### DESCRIPTION OF THE EMBODIMENTS

The circular saw 10 as the cutter according to this embodiment will be described below with reference to the drawings. The arrow UP, arrow FR, and arrow LH, indicated as appropriate in the drawings, indicate the upper, front, and left sides of the circular saw 10, respectively. In the following description, when using directions such as up and down, front and rear, and left and right, unless otherwise specified, it refers to the up-down direction, front-rear direction, and left-right direction of the circular saw 10.

The circular saw 10 is configured as a power tool for cutting workpieces. Specifically, by placing the circular saw 10 on the workpiece and moving toward the front side of the workpiece, a cutting process is performed on the workpiece.

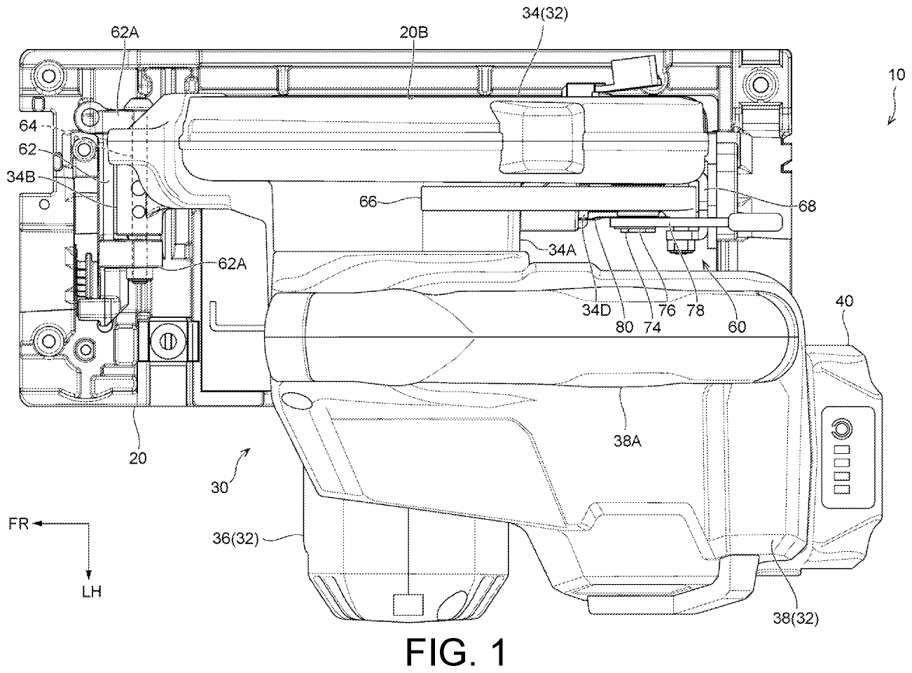

As shown in FIG. 1 to FIG. 4, the circular saw 10 includes a base 20, a circular saw body 30 as the main body part, a protrusion-amount-adjusting mechanism 60 for connecting the circular saw body 30 to the base 20 and adjusting the protrusion amount of the circular saw blade 12 of the circular saw body 30 from the base 20. Each configuration of the circular saw 10 will be described below.

(Regarding the base 20) The base 20 is made of metal and is formed into a substantially rectangular plate shape with the up-down direction as the plate thickness direction and the front-rear direction as the longitudinal direction. The bottom surface of the base 20 is configured as a sliding surface 20A, when using the circular saw 10 for cutting, the sliding surface 20A is placed on the workpiece and slides on the workpiece.

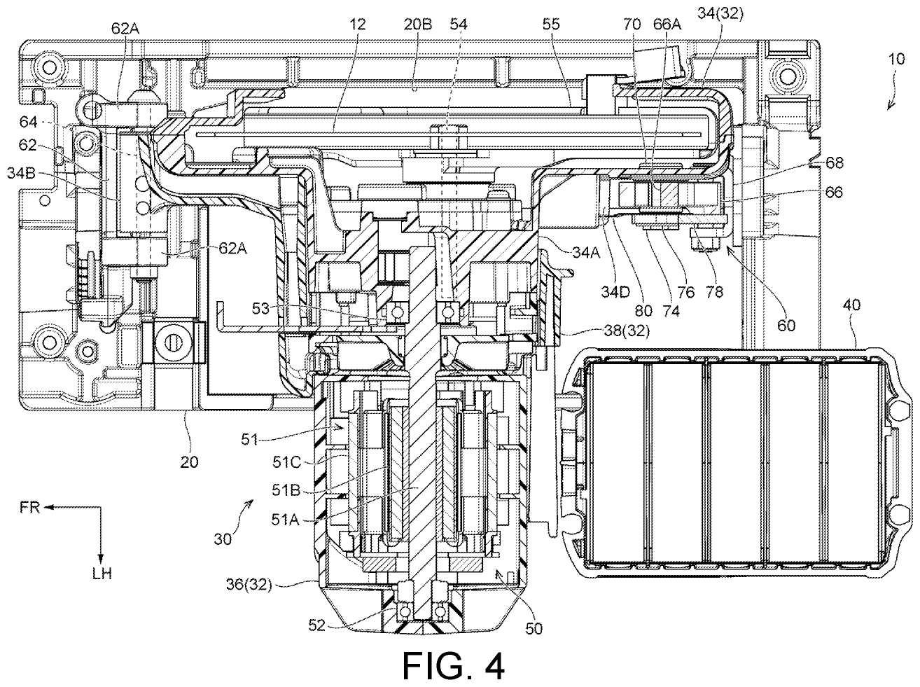

An insertion part 20B (see FIG. 4) is formed through the right part of the base 20 for configuring the circular saw blade 12 as the cutting blade. The insertion part 20B is formed into a substantially rectangular shape with the front-rear direction as the longitudinal direction. Here, the circular saw blade 12 is formed into a substantially disk shape with the left-right direction as the plate thickness direction, and the center part of the circular saw blade 12 is integrally rotatably fixed to an output shaft 54 of a drive mechanism 50, which will be described later. Then, the circular saw blade 12 is placed in the insertion part 20B, the upper part of the circular saw blade 12 protrudes to the upper side (one side of the plate thickness direction of the base 20) from the base 20, and the lower end side part of the circular saw blade 12 protrudes to the lower side (the other side of the plate thickness direction of the base 20) from the base 20. That is, the insertion part 20B is for causing a part of the circular saw blade 12 to protrude from the bottom surface of the base 20 toward the workpiece side (opposite side of the circular saw body 30).

(Regarding the circular saw body 30) The circular saw body 30 includes a housing 32, a drive mechanism 50, and a battery 40.

(Regarding the housing 32) The housing 32, which is formed of multiple housing members, forms the outer shell of the circular saw body 30 and is configured on the upper side of the base 20. The housing 32 is connected to the base 20 by the protrusion-amount-adjusting mechanism 60, which will be described later. The connection of the housing 32 to the base 20 will be described later. The housing 32 includes a saw cover part 34 that covers the circular saw blade 12, a motor housing part 36 that accommodates the drive mechanism 50 that will be described later, and a battery holder part 38 to which the battery 40 is mounted.

The saw cover part 34 configures the right end part of the housing 32. The saw cover part 34 is formed into a substantially semicircular disk shape with the left-right direction as the thickness direction and is convex to the upper side, which is also formed in a concave shape that opens to the lower side. Then, the upper part of the circular saw blade 12 is accommodated within the saw cover part 34 and covered by the saw cover part 34. At the lower end part of the left wall of the saw cover part 34, a cover cylindrical part 34A is formed into a substantially cylindrical shape that protrudes toward the left side in the middle part of the front-rear direction. A connecting cylindrical part 34B is integrally formed at the front end part of the saw cover part 34, and the linkage cylindrical part 34B is formed into a substantially cylindrical shape with the left-right direction as the axial direction.

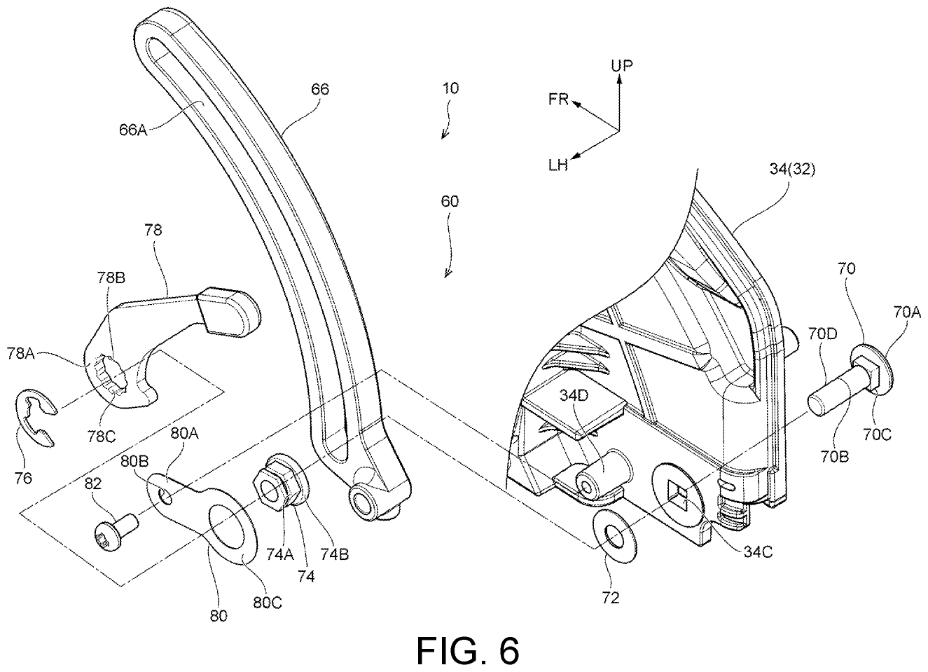

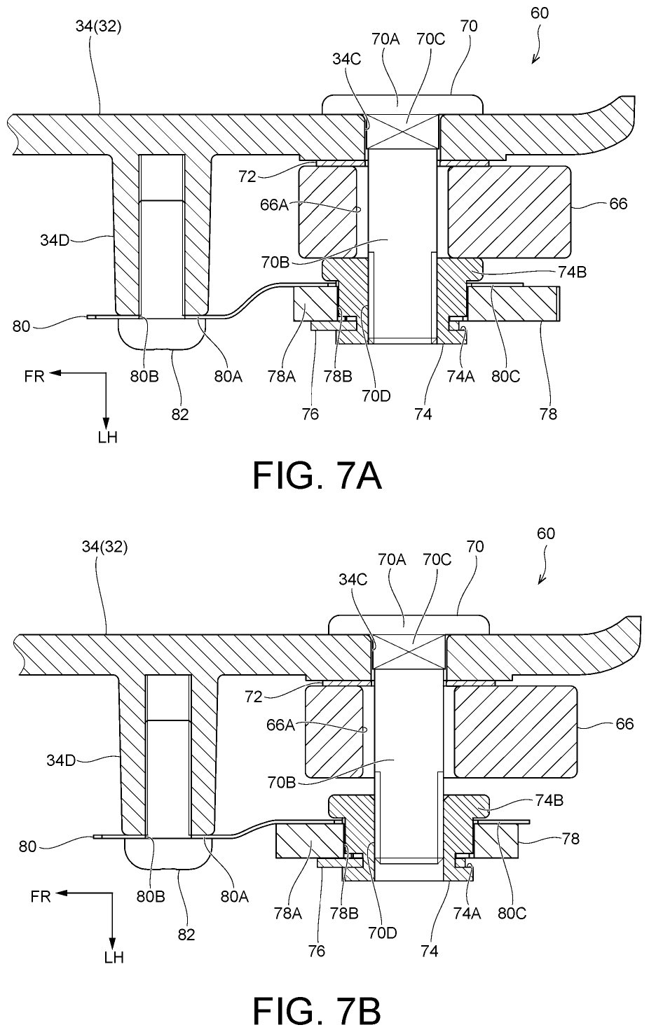

A locking hole 34C (see FIG. 6) for locking the fixing bolt 70 of the protrusion-amount-adjusting mechanism 60, which will be described later, is formed through the rear end part of the left wall of the saw cover part 34. The locking hole 34C is formed into a square shape. Further, on the left wall of the saw cover part 34, a fixed boss 34D (see FIG. 6) for fixing the lever-biasing spring 80 of the protrusion-amount-adjusting mechanism 60, which will be described later, is integrally formed on the front side of the locking hole 34C, and the fixed boss 34D is formed into a substantially circular cylindrical shape with the left-right direction as the axial direction and protrudes from the saw cover part 34 to the left side.

The motor housing part 36 is formed into a bottomed cylindrical shape that entirely opens to the right side. The motor housing part 36 is configured on the left side of the cover cylindrical part 34A of the saw cover part 34 and is fastened and fixed to the cover cylindrical part 34A.

The battery holder part 38 is configured on the upper side of the motor housing part 36 and is fastened and fixed to the cover cylindrical part 34A of the saw cover part 34. The battery holder part 38 protrudes further to the rear side than the motor housing part 36, and the rear part of the battery holder part 38 is configured spaced apart from the left side relative to the saw cover part 34. In the rear part of the battery holder part 38, a battery 40 is mounted from the rear side, and the battery 40 is configured on the lower side of the battery holder part 38 and the rear side of the motor housing part 36. The battery 40 is electrically connected to a controller (not shown in the drawings) and a motor 51 of the drive mechanism 50 to be described later.

A handle part 38A is provided on the upper side of the battery holder part 38. The handle part 38A is formed into a substantially U-shape that opens diagonally downward and forward when viewed from the left side, and two end parts of the handle part 38A are connected to the battery holder part 38. A trigger 42 is provided in the handle part 38A so that the trigger 42 may be pulled. The trigger 42 is electrically connected to the controller and the drive mechanism 50, which will be described later, operates in response to the operation of the trigger 42.

(Regarding the drive mechanism 50) As shown in FIG. 4, the drive mechanism 50 includes a motor 51 and an output shaft 54. The motor 51 is configured as a brushless motor accommodated in the motor housing part 36 and is electrically connected to the controller. The motor 51 includes a rotary shaft 51A with the left-right direction as the axial direction, a rotor 51B integrally rotatably provided on the rotary shaft 51A, and a stator 51C formed in a cylindrical shape and configured on the radially outer side of the rotor 51B. Then, the left end part of the rotary shaft 51A is rotatably supported by a first motor bearing 52 fixed to the motor housing part 36, and the right side part of the rotary shaft 51A is rotatably supported by a second motor bearing 53 fixed to the saw cover part 34. The right end part of the rotary shaft 51A protrudes to the right side from the second motor bearing 53, and a pinion gear is formed at the right end part of the rotary shaft 51A.

The output shaft 54, with the left-right direction as the axial direction, is configured on the lower side the right end part of the rotary shaft 51A and is rotatably supported by the housing 32. An output gear that is not shown in the drawings is rotatably provided at the left end part of the output shaft 54, and the output gear is engaged with the pinion gear of the rotary shaft 51A. The center part of the circular saw blade 12 is fixed to the right end part of the output shaft 54. In this way, the output shaft 54 and the circular saw blade 12 are configured to rotate around the axis of the output shaft 54 when the motor 51 is driven.

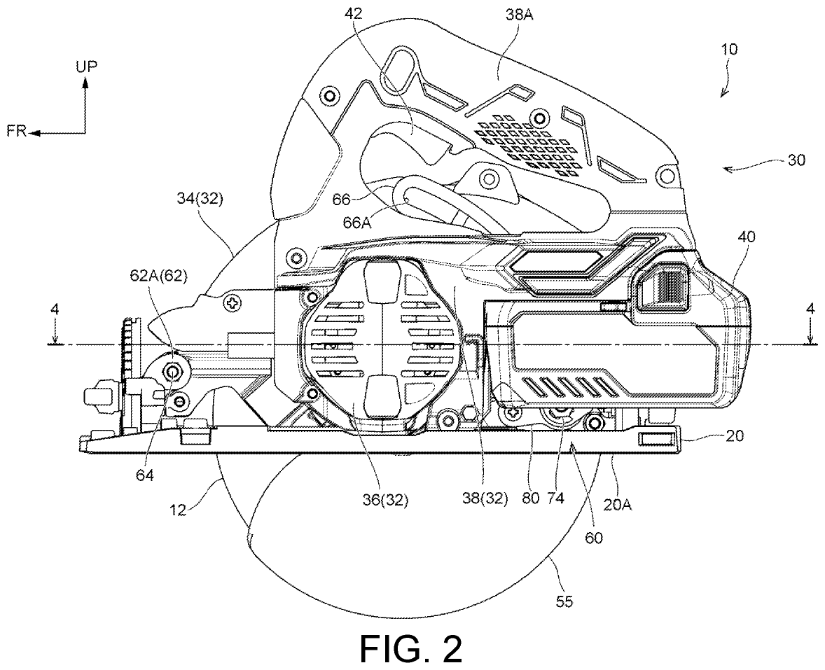

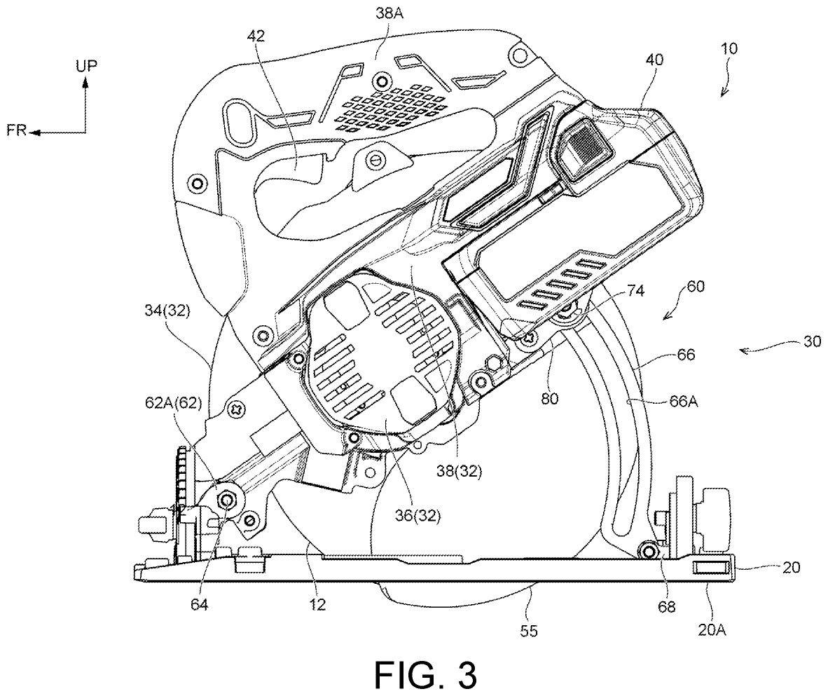

It should be noted that the lower part of the circular saw blade 12 is covered with a protecting cover 55 (see FIG. 2 and FIG. 3). The protecting cover 55 is formed into a substantially semicircular shape that is convex to the lower side when viewed from the left side, and is also formed in a concave shape that opens to the upper side. Moreover, the protecting cover 55 is connected to the output shaft 54 so as to be rotatable around the axis of the output shaft 54. Further, the protecting cover 55 is energized around the axis of the output shaft 54 by an energizing spring that is not shown in the drawings and is held at the position shown in FIG. 2 and FIG. 3. Then, when using the circular saw 10 for cutting, the protecting cover 55 rotates around the axis of the output shaft 54 against the energizing force of the energizing spring by the workpiece, and the blade part of the circular saw blade 12 is exposed.

(Regarding the protrusion-amount-adjusting mechanism 60) As shown in FIG. 1 to FIG. 7, the protrusion-amount-adjusting mechanism 60 is configured as a mechanism for connecting the circular saw body 30 to the base 20 and a mechanism for adjusting the protrusion amount of the circular saw blade 12 from the base 20 (sliding surface 20A) to the lower side. The protrusion-amount-adjusting mechanism 60 includes a front side connecting member 62, a link 66, a fixing bolt 70 as a fixing part, a fixing nut 74 as a pressing part, an operation lever 78 as a lever, and a lever-biasing spring 80 as an energizing part.

The front side connecting member 62 is formed in a substantially block shape extending in the left-right direction, configured on the front side of the saw cover part 34, and fixed to the base 20. The front side connecting member 62 has connecting parts 62A provided on two end parts in the left-right direction, respectively, the connecting parts 62A protrude from the front side connecting member 62 to the rear side and is configured adjacent to the outer side of the connecting cylindrical part 34B of the saw cover part 34 in the left-right direction. A support shaft 64 with the left-right direction as the axial direction is extended between the pair of connecting parts 62A. The support shaft 64 is inserted through the connecting cylindrical part 34B and rotatably supports the linkage cylindrical part 34B. In this way, the front end part of the saw cover part 34 (circular saw body 30) is rotatably connected to the base 20 with the left-right direction as the axial direction. Specifically, the circular saw body 30 is connected to the base 20 so as to be rotatable between a maximum protrusion position (the position shown in FIG. 2) and a minimum protrusion position (the position shown in FIG. 3).

The link 66 is located adjacent to the left side of the rear part of the saw cover part 34. Specifically, the link 66 is configured between the saw cover part 34, the battery holder part 38, and the battery 40. The link 66 is formed into a substantially elongated block shape with the left-right direction as the thickness direction, and is curved in an arc shape convex substantially rearward and diagonally upward when viewed from the side. Specifically, the link 66 is curved in a substantially arc shape with the support shaft 64 as the center when viewed from the side. Then, the lower end part of the link 66 is fixed to the base 20 by a fixing plate 68. A link hole 66A is formed through the link 66 in the left-right direction, and the link hole 66A is formed into a long hole shape extending along the longitudinal direction of the link 66.

The fixing bolt 70 is configured with the left-right direction as the axial direction. The fixing bolt 70 includes a head part 70A configuring a base end part of the fixing bolt 70 and a bolt body 70B extending to the left side from the head part 70A. The head part 70A is formed into a substantially disk shape with the left-right direction as the plate thickness direction. The bolt body 70B is formed into a substantially columnar shape with a smaller diameter than the head part 70A. A locking part 70C is formed on the base end part of the bolt body 70B, and the locking part 70C is formed in a square shape similar to the locking hole 34C of the saw cover part 34 when viewed from the axial direction of the fixing bolt 70. The fixing bolt 70 is inserted into the locking hole 34C on the left wall of the saw cover part 34 from the right side, and the locking part 70C is fitted into the locking hole 34C. As a result, the fixing bolt 70 is relatively non-rotatably connected to the saw cover part 34 and protrudes from the saw cover part 34 to the left side. In addition, in the connection state of the fixing bolt 70 to the saw cover part 34, the length of the locking part 70C in the axial direction of the fixing bolt 70 is set so that the locking part 70C does not protrude further to the left side than the saw cover part 34 (see FIGS. 7(A) and (B)).

The fixing bolt 70 (bolt body 70B) is relatively movably inserted into the link hole 66A, and when adjusting the protrusion amount of the circular saw blade 12, the fixing bolt 70 moves within the link hole 66A along the longitudinal direction of the link 66. Then, at the maximum protrusion position of the circular saw body 30, the fixing bolt 70 is configured at the lower end part of the link hole 66A, and at the minimum protrusion position of the circular saw body 30, the fixing bolt 70 is configured at the upper end part of the link hole 66A. The tip end part of the bolt body 70B is configured as a threaded part 70D, and a male thread is formed in the outer circumferential part of the threaded part 70D. The threaded part 70D protrudes further to the left side than the link 66. It should be noted that a washer 72 is mounted to the fixing bolt 70, and the washer 72 is configured between the link 66 and the saw cover part 34.

The fixing nut 74 is configured as a hexagon nut with a flange. The fixing nut 74 is screwed into the threaded part 70D of the fixing bolt 70 and attached to the tip end part of the fixing bolt 70. As a result, when viewed from the tip end side of the fixing bolt 70, by rotating the fixing nut 74 clockwise (one side of the rotating direction), the fixing nut 74 is displaced to the base end side (link 66 side) of the fixing bolt 70. Then, the fixing nut 74 presses the link 66 to the right side (the side of the saw cover part 34), by the tightening force acting from the fixing bolt 70 and the fixing nut 74 to the saw cover part 34 and the link 66, the link 66 (base 20) and the saw cover part 34 (circular saw body 30) are fixed. On the other hand, in the fixing state of the base 20 and the circular saw body 30, by rotating the fixing nut 74 counterclockwise (other side of the rotating direction), the fixing nut 74 is displaced to the tip end side (direction away from the link 66) of the fixing bolt 70, and the fixing state of the link 66 (base 20) and the saw cover part 34 (circular saw body 30) is released. That is, in the fixing release state of the link 66 and the saw cover part 34, the fixing nut 74 is configured at a non-fixed position (the position shown in FIG. 7(B)) spaced apart from the link 66 to the left side. Then, the operation lever 78, which will be described later, is operated by the worker, by displacing the fixing nut 74 from the non-fixed position to the fixed position (the position shown in FIG. 7(A)) to the right side, the link 66 and the saw cover part 34 transition to the fixing state.

A locking groove 74A is formed on the outer circumferential part of the left end part of the fixing nut 74, and the locking groove 74A extends in the circumferential direction of the fixing nut 74 and is formed over the entire circumference of the fixing nut 74. An e-ring 76 as the stopper is locked to the locking groove 74A. Further, a flange 74B is formed at the right end part of the fixing nut 74 and extends to the radially outer side of the fixing nut 74.

The operation lever 78 is formed into a substantially elongated plate shape with the left-right direction as the thickness direction. One end part of the operation lever 78 is configured as a lever engaging part 78A, and an engaging hole 78B is formed through the lever engaging part 78A. As a result, the lever engaging part 78A is formed into a substantially annular plate shape. The inner circumferential part of the engaging hole 78B is formed in a zigzag shape. Specifically, multiple (twelve in this embodiment) engaging grooves 78C are formed in the inner circumferential part of the engaging hole 78B. The engaging grooves 78C are formed in a substantially V-shape open to the center side of the engaging hole 78B, and are configured at equal intervals in the circumferential direction of the engaging hole 78B. Then, the fixing nut 74 is inserted into the engaging hole 78B of the operation lever 78 from the right side, and the lever engaging part 78A is mounted to the radially outer side of the fixing nut 74.

In the mounting state of the lever engaging part 78A to the fixing nut 74, the operation lever 78 and the fixing nut 74 are engaged in the circumferential direction of the fixing nut 74 by the inner circumferential shape of the engaging hole 78B and the outer circumferential shape of the fixing nut 74. As a result, the operation lever 78 and the fixing nut 74 are integrally rotatably engaged, and the fixing nut 74 is displaced between the non-fixed position and the fixed position by the worker's operation of the operation lever 78. Specifically, by rotating the operation lever from the position shown by the two-dot line to the position shown by the solid line in FIG. 5, the link 66 and the saw cover part 34 transition from the non-fixing state to the fixing state. It should be noted that movement of the operation lever 78 to the left side is restricted by the e-ring 76. Furthermore, the other end part of the operation lever 78 is configured as a gripper to be held by the worker.

The lever-biasing spring 80 is configured as a metal plate spring. The lever-biasing spring 80 is formed into a substantially elongated plate shape with the left-right direction as the plate thickness direction and extends in the front-rear direction. The front end part (one end part) of the lever-biasing spring 80 is configured as a spring fixing part 80A, and a fixing hole 80B is formed through the spring fixing part 80A. The spring fixing part 80A is configured adjacent to the left side of the fixed boss 34D of the saw cover part 34, and is fastened and fixed to the fixed boss 34D by a fixing screw 82. Specifically, the fixing screw 82 is inserted into the fixing hole 80B and screwed onto the fixed boss 34D, and the lever-biasing spring 80 is fastened and fixed to the saw cover part 34.

The rear end part (other end part) of the lever-biasing spring 80 is configured as a mounting part 80C, and the mounting part 80C is formed in a substantially annular plate shape. Then, the mounting part 80C is mounted to the fixing nut 74. Specifically, the mounting part 80C is extrapolated to the fixing nut 74 so that the mounting part 80C is configured between the flange 74B of the fixing nut 74 and the operation lever 78. That is, after mounting the lever-biasing spring 80 to the fixing nut 74, the operation lever 78 is mounted to the fixing nut 74, and after the operation lever 78 is mounted to the fixing nut 74, the e-ring 76 is assembled to the fixing nut 74. Further, the distance between the flange 74B and the e-ring 76 in the left-right direction is slightly longer than the sum of the plate thickness of the lever-biasing spring 80 and the plate thickness of the operation lever 78.

Here, at the non-fixed position of the fixing nut 74, the mounting part 80C is configured further on the right side than the spring fixing part 80A in the lever-biasing spring 80. That is, at the non-fixed position of the fixing nut 74, the lever-biasing spring 80 is elastically deformed to the right side, and the mounting part 80C is mounted to the fixing nut 74. In this way, the lever-biasing spring 80 energizes the operation lever 78 toward the left side (the tip end side of the fixing bolt 70 and the direction away from the link 66), and the lever engaging part 78A of the operation lever 78 abuts against the e-ring 76. That is, the energizing force of the lever-biasing spring 80 to the left side is applied directly to the operation lever 78 and is applied to the fixing nut 74 through the e-ring 76. Then, the operation lever 78 is rotated, and by displacing the fixing nut 74 from the non-fixed position to the fixed position against the energizing force of the lever-biasing spring 80, the circular saw body 30 is fixed to the base 20.

(Operations and effects) Next, the operation and effect of this embodiment will be described.

In the circular saw 10 with the above configuration, the housing 32 of the circular saw body 30 is connected and fixed to the base 20 by the protrusion-amount-adjusting mechanism 60. That is, as shown in FIG. 7(A), the fixing nut 74 presses the link 66 to the right side, and the link 66 and the saw cover part 34 are tightened from the outer side in left-right direction by the head part 70A of the fixing bolt 70 and the fixing nut 74. Then, when adjusting the cutting amount (cutting depth) for the workpiece, the operation lever 78 is operated, the fixing state between the circular saw body 30 and the base 20 is released by the protrusion-amount-adjusting mechanism 60, and the circular saw body 30 is caused to rotate relative to the base 20. Specifically, by rotating the operation lever 78 from the position shown by the solid line to the position shown by the two-dot line in FIG. 5, the fixing nut 74 is rotated counterclockwise when viewed from the left side. This causes the fixing nut 74 to be displaced from the fixed position to the non-fixed position on the left side. As a result, as shown in FIG. 7(B), the fixing nut 74 is spaced apart from the link 66 to the left side, and the tightening of the link 66 by the fixing nut 74 and the saw cover part 34 is released. Thus, the fixing state of the circular saw body 30 and the base 20 is released.

Here, the protrusion-amount-adjusting mechanism 60 includes the lever-biasing spring 80, and the lever-biasing spring 80 energizes the fixing nut 74 and the operation lever 78 toward the tip end side (i.e., the direction away from the link 66) of the fixing bolt 70. Thus, the state of the fixing nut 74 configured at the non-fixed position may be retained well. That is, the separation state of the fixing nut 74 and the operation lever 78 from the link 66 may be retained well. In this way, in the fixing release state of the circular saw body 30 and the base 20, when the circular saw body 30 is rotated relative to the base 20, the fixing nut 74 and the operation lever 78 may be prevented from sliding on the link 66. Thus, workability when adjusting the protrusion amount of the circular saw blade 12 may be improved.

Further, the fixing nut 74 is provided with the e-ring 76, and the movement of the fixing bolt 70 to the tip end side in the operation lever 78 is restricted by the e-ring 76. The operation lever 78 is abutted against the e-ring 76 by the energizing force of the lever-biasing spring 80. Thus, the energizing force of the lever-biasing spring 80 may be directly applied to the operation lever 78, and the energizing force of the lever-biasing spring 80 may be applied indirectly to the fixing nut 74 through the e-ring 76. Also, since the operation lever 78 is abutted against the e-ring 76 by the energizing force of the lever-biasing spring 80, the operation lever 78, the e-ring 76, and the fixing nut 74 may be integrated by the energizing force. In this way, the rattling of the operation lever 78 extrapolated to the fixing nut 74 with relative to the fixing nut 74 is suppressed.

Further, the threaded part 70D is formed at the tip end part of the fixing bolt 70, and the fixing nut 74 is screwed into the threaded part 70D. In this way, with a simple configuration, the fixing nut 74 may abut against and separated from the link 66, and the circular saw body 30 and the base 20 may be switched to the fixing state or the non-fixing state.

Further, the lever-biasing spring 80 is configured as a plate spring. Then, one end part of the lever-biasing spring 80 is fixed to the fixed boss 34D of the saw cover part 34, and the other end part of the lever-biasing spring 80 energizes the operation lever 78 toward the tip end side of the fixing bolt 70. As a result, the lever-biasing spring 80 may be provided in the circular saw body 30 with a simple configuration, and a lever-biasing spring 80 provided in the circular saw body 30 may energize the operation lever 78 toward the tip end side of the fixing bolt 70.

In addition, the lever engaging part 78A of the operation lever 78 and the mounting part 80C of the lever-biasing spring 80 are mounted to the fixing nut 74, and the lever engaging part 78A and the mounting part 80C are sandwiched between the flange 74B and the e-ring 76 of the fixing nut 74. In this way, the deviation of the lever engaging part 78A and the mounting part 80C may be suppressed. Thus, energizing of the lever-biasing spring 80 to the operation lever 78 may be stabilized.

In addition, the lever engaging part 78A of the operation lever 78 and the mounting part 80C of the lever-biasing spring 80 are formed in an annular shape, and the fixing nut 74 is extrapolated. As a result, the energizing force acting from the mounting part 80C to the lever engaging part 78A is allowed to be acted uniformly in the circumferential direction of the lever engaging part 78A. In this way, the operation lever 78 may be well retained by the lever-biasing spring 80.

In this embodiment, although the energizing force of the lever-biasing spring 80 is configured to act on the one end part (lever engaging part 78A) of the operation lever 78, the part where the energizing force of the lever-biasing spring 80 is applied to the operation lever 78 is not limited thereto. For example, by causing the other end part of the lever-biasing spring 80 to abut against the middle part of the operation lever 78 in the longitudinal direction, the energizing force of the lever-biasing spring 80 may be acted on the middle part of the operation lever 78 in the longitudinal direction.

Moreover, although the mounting part 80C of the lever-biasing spring 80 is formed into an annular plate shape, the shape of the mounting part 80C is not limited thereto. For example, the mounting part 80C may be formed into a substantially U-shaped plate that is open to the rear side, and the fixing nut 74 may be configured within the mounting part 80C.

### REFERENCE SIGNS LIST

10 . . . Circular saw (cutter) 12 . . . Circular saw blade (cutting blade) 20 . . . Base 30 . . . Circular saw body (main body part) 60 . . . Protrusion-amount-adjusting mechanism 66 . . . Link 66A . . . Link hole 70 . . . Fixing bolt (fixing part) 70D . . . Threaded part 74 . . . Fixing nut (pressing part) 76 . . . E-ring (stopper) 78 . . . Operation lever (lever) 78A . . . Lever engaging part 80 . . . Lever-biasing spring (energizing part) 80C . . . Mounting part

1-6. (canceled)

7. A cutter, comprising:
a base, formed in a plate shape;
a main body part, provided on one side in a plate thickness direction of the base and supporting a cutting blade partially protruding toward other side in the plate thickness direction of the base; and
a protrusion-amount-adjusting mechanism, connecting the base and the main body part and adjusting a protrusion amount of the cutting blade from the base,
wherein the protrusion-amount-adjusting mechanism comprises:
a link, supported by the base and connected to the main body part;
a pressing part, provided in the main body part, regulating relative movement of the main body part to the base by pressing on the link, and allowing the relative movement of the main body part to the base by spacing apart from the link; and
a retaining member, provided in the main body part and retaining the pressing part spaced apart from the link.

8. The cutter according to claim 7, wherein the retaining member prevents the pressing part from moving in a direction closer to the link.

9. The cutter according to claim 7, wherein the pressing part is configured to receive resistance by the retaining member at a position further away from the link than a position of contact with the link when moving closer to the link.

10. The cutter according to claim 7, wherein the retaining member is configured to be elastically deformable.

11. The cutter according to claim 10, wherein the retaining member is configured to energizing the pressing part in a direction away from the link, and the pressing part is configured to receive energizing force from the retaining member at a position further away from the link than a position of contact with the link.

12. The cutter according to claim 11, wherein the pressing part is configured to rotate to move closer to or away from the link,
the pressing part is integrally rotatably connected to a lever operable by a worker, and
the energizing force from the retaining member is transmitted to the pressing part through the lever.

13. A cutter, comprising a base formed in a plate shape;
a main body part, provided on one side in a plate thickness direction of the base and supporting a cutting blade partially protruding toward other side in the plate thickness direction of the base; and
a protrusion-amount-adjusting mechanism, connecting the base and the main body part and adjusting a protrusion amount of the cutting blade from the base,
wherein the protrusion-amount-adjusting mechanism comprises:
a fixing part, extending from the main body part;
a link, supported by the base and having a link hole through which the fixing part is relatively movably inserted;
a pressing part, displacing to a base end side of the fixing part by rotating to one side in a rotating direction, pressing the link toward the base end side by contacting the link,
and displacing to tip end side of the fixing part by rotating to other side in the rotating direction to release pressure on the link; and
an energizing part, energizing the pressing part toward the tip end side of the fixing part when the pressure from the pressing part on the link is released, so that the pressing part is spaced apart from the link.

14. The cutter according to claim 13, wherein a threaded part is formed on the tip end side of the fixing part, and
the pressing part is screwed onto the threaded part and is displaced to the base end side or the tip end side of the fixing part by integrally rotating with a lever.

15. The cutter according to claim 13, wherein the pressing part is provided with a stopper that restricts movement of a lever to the tip end side of the fixing part, and the lever is abutted against the stopper by energizing force of the energizing part.

16. The cutter according to claim 15, wherein the energizing part is configured as a plate spring, and
one end part of the energizing part is supported by the main body part, and other end part of the energizing part energizes the lever toward the tip end side of the fixing part.

17. The cutter according to claim 15, wherein the lever comprises a lever engaging part mounted to the pressing part and engaged with the pressing part,
other end part of the energizing part is provided with a mounting part mounted to the pressing part and configured adjacent to a base end side of the fixing part relative to the lever engaging part, and
the stopper is configured adjacent to the tip end side of the fixing part relative to the lever engaging part.

18. The cutter according to claim 17, wherein the pressing part is configured as a hexagon nut, and
the lever engaging part and the mounting part are formed in an annular shape configured on a radially outer side of the pressing part.

19. The cutter according to claim 13, wherein the pressing part is configured to receive energizing force from the energizing part at a position further away from the link than a position of contact with the link.

20. A cutter, comprising a base formed in a plate shape;
a main body part, provided on one side in a plate thickness direction of the base and supporting a cutting blade partially protruding toward other side in the plate thickness direction of the base; and
a protrusion-amount-adjusting mechanism, connecting the base and the main body part and adjusting a protrusion amount of the cutting blade from the base,
wherein the protrusion-amount-adjusting mechanism comprises:
a fixing part, extending from the main body part;
a link, supported by the base and connected to the main body part;
a pressing part, rotatably provided in the fixing part, displacing to a base end side of the fixing part by rotating to one side in a rotating direction, pressing the link toward the base end side by contacting the link, and displacing to tip end side of the fixing part by rotating to other side in the rotating direction to release pressure on the link; and
a boss part, supporting the pressing part at a position spaced apart from the pressing part in a direction perpendicular to a rotation axis of the pressing part.
